(19) United States
(12) Patent Application Publication
(10) Pub. No.: US 2019/0381518 A1
(43) Pub. Date: Dec. 19, 2019

(54) Selective Polysaccharide Agents and Flocculants for Mineral Ore Beneficiation

(71) Applicant: Kemira OYJ, Helsinki (FI)

(72) Inventors: Sergio Cabo, Niterói, RJ (BR); Marcelo Moreira Da Costa, Ipatinga, MG (BR); Xihui Yin, Norcross, GA (US)

(21) Appl. No.: 16/480,548

(22) PCT Filed: Feb. 7, 2018
(86) PCT No.: PCT/US18/17263

§ 371 Date: Jul. 24, 2019

Related U.S. Application Data
(60) Provisional application No. 62/455,866, filed on Feb. 7, 2017.

(51) Int. Cl. B03D 1/02; B03D 1/016; B03D 3/06

(52) U.S. Cl. CPC B03D 1/025; B03D 1/016; B03D 2203/04; B03D 2201/002; B03D 3/06

(57) ABSTRACT

Selective polysaccharide agents or flocculants comprise one or more types of polysaccharides comprising one or more types of pentosan units. Also disclosed are processes for enriching a desired mineral from an ore comprising the desired mineral and gangue and/or other minerals, wherein the process comprises treating the ore in an aqueous medium with one or more selective polysaccharide agents or flocculants comprising one or more types of polysaccharides comprising one or more types of pentosan units.

### CROSS-REFERENCE TO RELATED APPLICATION

This application claims priority to U.S. Provisional Application No. 62/455,866, filed Feb. 7, 2017.

### FIELD OF THE ART

The present invention relates to selective polysaccharide agents and flocculants for the beneficiation of mineral ores.

### BACKGROUND

Although iron is the fourth most abundant element in the Earth's crust, the vast majority is bound in silicate, or more rarely, carbonate minerals. The thermodynamic barriers to separating pure iron from these minerals are formidable and energy intensive, therefore common sources of iron used by industry exploit comparatively rarer high-grade iron oxide minerals, primarily hematite. Most reserves of such high-grade ore have now been depleted, leading to development of lower-grade iron ore sources, for example, magnetite and taconite. The iron content of these lower-grade ores may be concentrated (upgraded) to a higher iron content through various concentration (beneficiation) processes, for example, to meet the quality requirement of iron and steel industries.

In the face of dwindling reserves of high grade iron ores, it is expected that greatly increased tonnage of lower-grade iron ores will be recovered in the foreseeable future. The processing of lower grade ore sources involves the removal of unwanted minerals (such as silicates and carbonates) which are an intrinsic part of the ore rock itself (gangue). In these beneficiation processes, the gangue is separated using techniques like crushing, grinding, milling, gravity or heavy media separation, screening, magnetic separation, and/or froth flotation to improve the concentration of the desired minerals and remove impurities.

Despite the improvements in recovery and concentration of desired minerals provided by the various beneficiation processes, losses of the valuable ore are still incurred during processing, for example, in the desliming stage (for instance, by filtration, settling, syphoning or centrifuging) used to eliminate the finest fraction of particulates. Significant amounts of fine particulate valuable ore that remains dispersed may be lost in the slime fraction. That portion of the valuable mineral or minerals that is inadvertently removed with the slime fraction may be permanently lost from the process. Even a small increase in the recovery or grade of desired mineral or minerals can result in significant economic benefits.

In an effort to improve valuable ore recovery, a modified flotation system was developed which involved a pre-conditioning of the ores by dispersing the finely ground ore in an aqueous medium and initially subjecting it to a selective flocculation process. Following the selective flocculation stage, the system is deslimed to remove the silica-bearing fines and the flocculated iron-containing residues are then concentrated to final grade by flotation and removal of the non-ferrous siliceous material. In selective flocculation, the flocculants are added prior to the flotation and desliming stages and are selective in their flocculating properties so as to effectuate a separation between mineral species contained in the aqueous dispersion. In an oxidized iron ore system, the selective flocculant causes the flocculation of iron containing particles while leaving the non-ferrous siliceous materials in suspension.

Selective flocculants presently known in the art include tapioca flour, potato starch, natural and modified starches, and polyacrylamides and synthetic flocculants, for example, as taught in U.S. Pat. No. 3,292,780, to Frommer et al. U.S. Pat. No. 4,081,357, to Werneke et al., U.S. Pat. No. 4,274,945, and European Patent No. 0232679 B 1.

### BRIEF SUMMARY

In view of the foregoing, one or more embodiments described herein include processes for enriching a desired mineral or material from an ore having iron-containing material and/or silicate-containing gangue, includes treating the ore in an aqueous medium with one or more selective polysaccharide agents or flocculants comprising one or more types of pentosan units. Also described herein are processes for enriching, or facilitating recovery of, a desired mineral from a tailings stream comprising the desired mineral and gangue and/or other minerals, wherein the process comprises treating the tailings stream with the one or more selective polysaccharide agents or flocculants.

The disclosure may be understood more readily by reference to the following detailed description of the various features of the disclosure and the examples included therein.

### DETAILED DESCRIPTION

According to the various embodiments described herein, selective polysaccharide agents may be used to improve the grade and/or recovery of valuable minerals from mineral-containing ore. In certain embodiments, processes use the selective polysaccharide agents to selectively flocculate mineral values to facilitate separation of desired mineral values from an ore containing gangue or other minerals. n certain embodiments, the selective polysaccharide agents may be used to selectively flocculate an oxidized iron ore from its associated siliceous gangue. In some embodiments, the selective polysaccharide agents may also be used facilitate separation of niobium from an ore containing iron and niobium.

In embodiments, the process comprises dispersing a ground ore in an aqueous medium, such as a slime, and adding an effective amount of one or more selective polysaccharide agents or flocculants described herein. In embodiments, the selective polysaccharide agents or flocculant comprises one or more types of polysaccharides comprising one or more types of pentosan units. In certain embodiments, the ground ore is ore fines, or ore composed of particles smaller than about 10 microns.

In embodiments, the selective polysaccharide agents or flocculants, compositions and processes may be used to provide improved selectivity for the desired mineral compared to other agents or flocculants, such as starch or causticized starch. In particular, the selective agents or flocculants may provide increased desliming selectivity, decreased valuable ore fines loss, decreased sodium hydroxide consumption, and/or decreased landfill, especially as compared to starch-based flocculants.

Definitions

As used herein, “gangue” or “siliceous gangue” refers to the undesirable minerals in a material, for example, an ore deposit that contains both undesirable and desired minerals. Such undesirable minerals may include oxides of iron, aluminum, silica (e.g. quartz), titanium, sulfur and alkaline earth metals and the like. In certain embodiments, the gangue includes oxides of silica (e.g. SiO₂ or quartz), silicates or siliceous materials such as kaolinite, muscovite, smectite and the like.

As used herein, the terms “desired minerals” or “minerals of value” refer to any minerals (naturally occurring solid inorganic substances) that have value, and in particular, may be extracted from ore that contains the desired mineral and gangue. In certain embodiments, the desired mineral may be iron powder, hematite, magnetite, pyrite, chromite, goethite, marcasite, limonite, pyrrhotite or any other iron-containing minerals. In certain embodiments, the desired minerals include minerals in iron-containing ores, such as niobium. In certain embodiments, the desired minerals derived from a polymetallic sulphidic ore, wherein the desired minerals may comprise one or more metals such as copper, lead, zinc, iron, molybdenum, gold or silver. In certain embodiments, the iron in the mineral is not the desired mineral.

As used herein, “ore” refers to rocks and other deposits from which the desired minerals can be extracted. Other sources of the desired minerals may be included in the definition of “ore” depending on the identity of the desired mineral. The ore typically contains undesirable minerals or materials, also referred to herein as gangue.

As used herein, “iron ore” refers to rocks, minerals and other sources of iron from which metallic iron may be extracted. The ores are usually rich in iron oxides and vary in color from dark grey, bright yellow, deep purple, to rusty red. The iron is usually found in the form of magnetite (Fe₃O₄), hematite (Fe₂O₃), goethite (FeO(OH)), limonite (FeO(OH).n(H₂O)), siderite (FeCO₃) or pyrite (FeS₂). Taconite is an iron-bearing sedimentary rock in which the iron minerals are interlayered with quartz, chert, or carbonate. Itabirite, also known as banded-quartz hematite and hematite schist, is an iron and quartz formation in which the iron is present as thin layers of hematite, magnetite, or martite. Any of these types of iron are suitable for use in processes described herein. In embodiments, the iron ore is substantially magnetite, hematite, taconite or itabirite. In embodiments, the iron ore is substantially pyrite. In embodiments, the iron ore is contaminated with gangue materials, for example, oxides of aluminum, silica or titanium. In embodiments, the iron ore is contaminated with gangue. In embodiments, the iron ore is contaminated with clay, including, for example, kaolinite, muscovite or other silicates.

As used herein, a “pH adjuster”, “pH adjusting agent” or “pH regulator” refers to an agent that is used to change or control pH. Any suitable agent that is used to change or control pH may be used, including, for example, sodium hydroxide or ammonium hydroxide.

As used herein, the terms “polymer,” “polymers,” “polymeric,” and similar terms are used in their ordinary sense as understood by one skilled in the art, and thus may be used herein to refer to or describe a large molecule (or group of such molecules) that contains recurring units. Polymers may be formed in various ways, including by polymerizing monomers and/or by chemically modifying one or more recurring units of a precursor polymer. Unless otherwise specified, a polymer may be a “homopolymer” comprising substantially identical recurring units formed by, e.g., polymerizing a particular monomer. Unless otherwise specified, a polymer may also be a “copolymer” comprising two or more different recurring units formed by, e.g., copolymerizing two or more different monomers, and/or by chemically modifying one or more recurring units of a precursor polymer. Unless otherwise specified, a polymer may also be a “terpolymer” comprising three or more different recurring units.

As used herein, an “agent”, “selective agent” or “selective polysaccharide agent” refers to an agent that facilitates the separation of desired minerals from gangue and/or other minerals. In particular, an agent selectively enriches one fraction isolated from a beneficiation, flotation or flocculation process with the desired mineral while a second fraction is enriched in gangue. In embodiments, the selective flocculant is an agent that selectively enriches one fraction isolated from a beneficiation, flotation or flocculation process with the iron or iron oxide while a second fraction is enriched in gangue. In embodiments, the selective flocculant is an agent that selectively enriches one fraction isolated from a beneficiation, flotation or flocculation process while a second fraction containing iron or iron oxide is enriched in gangue.

As used herein, a “flocculant”, “selective flocculant” or “selective polysaccharide flocculant” refers to an agent that facilitates the agglomeration of particles in a suspension (such as a dispersed suspension). In particular, a selective flocculant selectively enriches one fraction isolated from a beneficiation, flotation, or flocculation process with the desired mineral while a second fraction is enriched in gangue. In embodiments, the selective flocculant is an agent that selectively enriches one fraction isolated from a beneficiation, flotation, or flocculation process with the iron or iron oxide while a second fraction is enriched in gangue. In embodiments, the selective flocculant is an agent that selectively enriches one fraction isolated from a beneficiation, flotation, or flocculation process while a second fraction containing iron or iron oxide is enriched in gangue.

As used herein, the term “polysaccharide” refers to carbohydrate molecules of repeated monomer (monosaccharide) units joined together by glycosidic bonds. The polysaccharide may vary in structure, for example, may be linear or branched. The molecules may contain slight modifications of the repeating unit. Monosaccharides are generally aldehydes or ketones with two or more hydroxyl groups. A polysaccharide containing a single type of monosaccharide unit is referred to as a homopolysaccharide, while a polysaccharide containing more than one type of monosaccharide unit is referred to as a heteropolysaccharide. Polysaccharides are generally considered to contain ten or more monosaccharide units, while the term “oligosaccharide” is generally used to refer to the polymers containing a small number, e.g. two to ten, of monosaccharide units.

As used herein, “hemicellulose” refers to the heteropolymer polysaccharide components of plant cell walls other than cellulose. Hemicelluloses have sugars called pentoses such as xylose, each having five carbon atoms as constituent units, sugars called hexoses such as mannose, arabinose and galacturonic acid, each having six carbon atoms as constituent units, and optionally complex polysaccharides such as glucomannan and glucuronoxylan. Hemicellulose can be any of several heteropolymers present in almost all plant cell walls, e.g., xylan, arabinoxylan, glucuronoxylan, glucuronoarabinoxylan. Typically, the main chain (i.e., backbone) is composed of β-1,4-linked D-xylopyranose residues. Besides xylose, hemicelluloses may contain arabinose, glucuronic acid or its 4-O-methyl ether, and acetic, ferulic, and p-coumaric acids. In some cases, the monomers branch off the xylan backbone. The frequency and composition of branches are dependent on the source. All types of hemicellulose may be used in the embodiments.

As used herein, the term “starch” refers to a carbohydrate consisting of a large number of glucose units joined by glycosidic bonds. It is well established that starch polymer consists mainly of two fractions, amylose and amylopectin, which vary with the source of starch. The amylose having a low molecular weight contains one end group per 200-300 anhydroglucose units. Amylopectin is of higher molecular weight and consists of more, than 5,000 anhydroglucose units with one end group for every 20-30 glucose units. While amylose is a linear polymer having α 1→4 carbon linkage, amylopectin is a highly branched polymer with α 1→4 and α 1→6 carbon linkages at the branch points.

As used herein the term “slime” or “slimes” refers to aqueous compositions including fine particles, such as particles smaller than about 10 microns. Slimes may be generated during the grinding stage of ore beneficiation processes, which is necessary to individualize the mineral species for subsequent concentration processes. However, some ore samples naturally contain fine particles. Desliming processes are used to remove very fine particles, including clays, phosphorus, aluminum, calcium manganese and iron compounds from the pulp prior to flotation processes, such as reverse cationic flotation.

Selective Polysaccharide Agents or Flocculants

In embodiments, the one or more selective polysaccharide agents may be selective in the beneficiation, flotation or flocculation of metal ores in particular, iron ores or other desirable minerals. In embodiments, the one or more selective polysaccharide agents may facilitate the separation of desired minerals from gangue or other minerals in an aqueous medium. In certain embodiments, the one or more selective polysaccharide flocculants may facilitate the separation of desired minerals from iron, iron oxide and/or gangue in an aqueous medium. In embodiments, the amount of isolation or separation achieved is at least about 40%, about 45%, about 50%, about 55%, about 60%, about 65%, about 70%, about 75%, about 80%, about 85%, or about 90% of the desired mineral in the aqueous medium. In embodiments, the amount of isolation or separation achieved is in the range of about 40% to about 90%, about 40% to about 60%, or about 45% to about 55% of the desired mineral in the aqueous medium.

In embodiments, the one or more selective flocculants may be selective in the flocculation of ultrafine aqueous dispersions of metal ores, in particular, iron ores or other desirable minerals. In certain embodiments, the one or more selective flocculants do not substantially flocculate gangue materials. The simultaneous presence of desirable minerals that may be separated by flocculation of gangue materials does not alter substantially the flocculation potential of the minerals. In embodiments, the amount of flocculation achieved is at least about 40%, about 45%, about 50%, about 55%, about 60%, about 65%, about 70%, about 75%, about 80%, about 85%, or about 90% of the desired mineral in the aqueous medium. In embodiments, the amount of flocculation achieved is in the range of about 40% to about 90%, about 40% to about 60%, or about 45% to about 55% of the desired mineral in the aqueous medium.

In embodiments, the selective polysaccharide agent comprises one or more types of polysaccharides comprising one or more types of pentosan units.

In certain-embodiments, the selective agent or flocculant having one or more types of polysaccharides comprising one or more types of pentosan units.

Pentosan units are monosaccharides having five carbon atoms, include, for example, xylose, ribose, arabinose, and lyxose. In certain embodiments, the pentosan unit may be an aldopentose, which has an aldehyde functional group at position 1, such as, for example, the D- or L-forms of arabinose, ribose, xylose and lyxose. Polysaccharides include, for example, xylan, hemicellulose, and gum arabic.

Hemicellulose is derived from lignocellulosic biomass, including, but not limited to: for example herbaceous crops, for example grasses, such as switch grass; wood, for example hardwood, such as pine wood, aspen wood and spruce wood; and agricultural residues, for example sugarcane bagasse, wheat straw, corn stover (which may include the stalk, leaves, husk and cob of the corn plant), corn fiber (corn bran or corn hull). In embodiments, the hemicellulose may contain mixtures of xylose, arabinose, mannose and galactose. Accordingly, any plant material comprising hemicellulose may be used in the prepare the selective polysaccharide agents or flocculants. In certain embodiments, the one or more selective polysaccharide agents or flocculants comprise hemicellulose. In certain embodiments, the one or more selective polysaccharide agents or flocculants comprise polysaccharides are derived from one or more types of lignocellulosic biomass.

Gum arabic may contain arabinose and ribose. In embodiments, the one or more types of pentosan units comprises xylan units and one or more of hemicellulose and aldopentoses.

In a particular embodiment, the one or more selective polysaccharide agents or flocculants are derived from a waste product of industrial processing. In certain embodiments, the one or more selective polysaccharide agents or flocculants are derived from corn fiber, corn stover and mixtures thereof.

Corn fiber comprises a matrix of hemicellulose, cellulose, and lignin. Any corn fiber may be used in the present method, including native corn fiber and corn fiber produced by standard breeding techniques including crossbreeding, translocation, inversion, transformation or any other method of gene or chromosome engineering to include variations thereof. Native corn is intended to mean those varieties found in nature, including dent, waxy, or high amylose corn. In embodiments, the corn fiber may be obtained from a wet-milling or a dry-milling process. Accordingly, the corn fiber may be wet or dry. In embodiments, the corn fiber may be dried and stored prior to use in preparing the polysaccharide agents or selective flocculants. The corn fiber may be de-starched corn-fiber. De-starched corn fiber is typically formed by liquefacation with α-amylase until at least part is soluble. Other methods of destarching known in the art are also suitable, including separation of the starch from the fiber, i.e., by a hydrocyclone, or by use of other enzyme(s) or combinations thereof.

In embodiments, the one or more types of polysaccharides are derived from algae. In certain embodiments, the one or more types of polysaccharides are not derived from algae.

In embodiments, the selective polysaccharide agent or flocculant may be a blend or a mixture of polysaccharides having one or more types of pentosan units. In certain embodiments, the selective polysaccharide agent or flocculant may consist essentially of polysaccharides comprising one type of pentosan unit, for example xylan. In certain embodiments, the one or more types of pentosan units comprise xylan. In embodiments, a selective polysaccharide agent or flocculant is provided that includes one or more types of polysaccharides comprising xylan units.

In embodiments, a polysaccharide comprising xylan may be extracted from plant material (e.g. lignocellulosic biomass) or from algae with dilute alkaline solutions, for example, as described in International Publication No. WO 2014/055502.

Xylan is an oligosaccharide which could be extracted in the form of 5 to 200 anhydroxylose units consisting of D-xylose units with 1β→4 linkages.

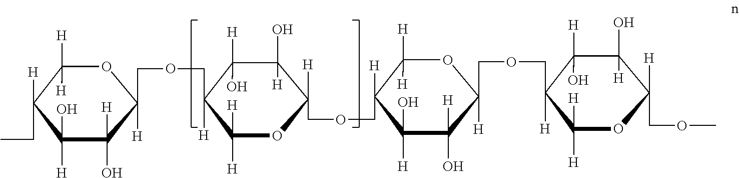

Xylan oligosaccharide with 5 to 200 anhydroxylose units consisting of D-xylose units with 1β→4 linkages

In embodiments, the polysaccharides comprising one or more types of pentosan unit may be extracted from the pulping black liquors, from the cold caustic extraction (CCE) filtrates, and/or from acid pre-hydrolyzes or auto-hydrolyzes process in order to achieve dissolve pulp grades. Such extractions are described in, for example, Jayapal et al. Industrial Crops and Products 2012, v. 42, pp. 14-24; Muguet et al. Holzforschung 2011, v. 65, pp. 605-612; and Gehmayer et al. Biomacromolecules 2012, v. 13, pp. 645-651.

In certain embodiments, the selective polysaccharide agents or flocculants do not comprise substantial amounts of arabinose or ribose or sources thereof.

In embodiments, the molecular weight of the selective polysaccharide agent or flocculant is about 700 to about 50,000; about 700 to about 25,000; or about 700 to about 8000 Daltons. In embodiments, the molecular weight of the selective polysaccharide agent or flocculant is about 5 to about 300, about 5 to about 150, or about 5 to about 50 aldopentose units, for example xylose units.

In embodiments, the selective agent may have any molecular weight so long as the selective agent has the effect of selectively flocculating the desired minerals in preference to flocculating the associated gangue. In certain embodiments, the selective agent may have any molecular weight so long as the selective agent has the effect of selectively flocculating the iron or iron oxide in preference to other minerals. In embodiments, the molecular weight of the selective flocculant is about 700 to about 50,000; about 700 to about 25,000; or about 700 to about 8000 Daltons. In embodiments, the molecular weight of the selective flocculant is about 5 to about 300, about 5 to about 150, or about 5 to about 50 aldopentose units, for example xylose units.

Compositions

In embodiments, a composition comprises one or more selective polysaccharide agents or flocculants, as described herein, and a solvent. In embodiments, a composition comprises one or more selective flocculants, as described herein, and a solvent. In embodiments, a composition comprises one or more selective flocculants and a solvent, wherein the one or more selective flocculants is one or more of the selective flocculants described herein.

In embodiments, the solvent is water. In embodiments, the composition is a solution, for example, an aqueous solution.

In embodiments, the composition is a gel, for example a polysaccharide gel. In embodiments, the gel is water-soluble.

A composition according to the embodiments may be formulated to provide a sufficient amount of one or more selective flocculants prior to a desliming process, i.e., an amount sufficient to produce a desired result.

In embodiments, the composition may further comprise one or more agents or modifiers known in the desliming art, such as dispersants. Examples of such agents or modifiers include, but are not limited to, sodium silicate and/or polyacrylic acid-based dispersants, or any other agent known in the art. Dispersants suitable for use in combination with the selective polysaccharide agents or flocculants are not particularly limited and include: KemEcal™ TC2500 (a sodium silicate and polyacrylic acid dispersant available from Kemira Chemicals, Inc.), sodium polyphosphate and the like.

In embodiments, the composition may be used in a process wherein the one or more agents or modifiers known in the desliming art, such as dispersants, are added separately.

In embodiments, the composition includes one or more conventional selective flocculants or a flocculant not included in the embodiments described herein. Other selective flocculants that may be used in combination with the polysaccharide agents or flocculants include, but are not limited to: starch, such as tapioca, corn, potato, wheat, rice and the like; starch activated by treatment with alkali; cellulose esters, such as carboxymethylcellulose and sulphomethylcellulose; cellulose ethers, such as methyl cellulose, hydroxyethylcellulose and ethyl hydroxyethylcellulose; hydrophilic gums, such as gum arabic, gum karaya, gum tragacanth and gum ghatti, alginates; starch derivatives, such as carboxymethyl starch and phosphate starch; and combinations thereof.

Processes

In certain embodiments, a process for enriching a desired mineral or material from an ore having the iron-containing material and/or silicate-containing gangue, includes treating the ore in an aqueous medium with one or more selective polysaccharide agents or flocculants described herein. In certain embodiments, a process for enriching an iron-containing mineral from an ore having the iron-containing material and silicate-containing gangue, includes treating the ore in an aqueous medium with one or more selective polysaccharide agents or flocculants described herein. In embodiments, the process comprises, or consists of, a beneficiation process. In embodiments, the process comprises, or consists of, a flotation process. In embodiments, the process comprises a flocculation process.

In certain embodiments, the process comprises the steps of:
(i) mixing a ground ore with a solvent to form a mixture;
(ii) adding the one or more selective polysaccharide agents of flocculants to the mixture;
(iii) agitating the mixture to distribute the selective polysaccharide agents of flocculants;
(iv) allowing flocs to form; and
(v) isolating the flocs.

In embodiments, a selective beneficiation, flotation or flocculation process comprises dispersing a ground ore in an aqueous medium to form a mixture, and adding one or more selective polysaccharide agents or flocculants described herein to the mixture. In embodiments, an effective amount of the one or more selective polysaccharide agents or flocculants is added to the mixture. In embodiments, the one or more selective polysaccharide agents or flocculants added to the mixture comprises one or more types of polysaccharides comprising one or more types of pentosan units. In embodiments, an effective amount of the one or more selective polysaccharide agents or flocculants is added to the mixture. In certain embodiments, the ground ore is ground iron ore or ground iron ore contaminated with gangue. In certain embodiments, the ground ore is ore containing niobium or ore containing niobium and iron. In certain embodiments, the ground ore is a polymetallic sulphidic ore containing desired minerals wherein the desired minerals comprise two or more metals selected from copper, lead, zinc, iron, molybdenum, gold and silver. In certain embodiments, the ground ore is a polymetallic sulphidic ore containing two or more metals selected from copper, lead, zinc, iron, molybdenum, gold and silver. In certain embodiments, the ground ore is a polymetallic sulphidic ore that comprises iron and one or more metals selected from copper, lead, zinc, iron, molybdenum, gold and silver.

In embodiments, a selective flocculation process comprises dispersing a ground ore in an aqueous medium to form a mixture, and adding one or more selective flocculants described herein to the mixture. In embodiments, an effective amount of the one or more selective flocculants is added to the mixture. In embodiments, the one or more selective flocculants added to the mixture comprises one or more types of polysaccharides comprising one or more types of pentosan units. In embodiments, an effective amount of the one or more selective flocculants is added to the mixture. In certain embodiments, the ground ore is ground iron ore or ground iron ore contaminated with gangue. In certain embodiments, the ground ore is ore containing niobium or ore containing niobium and iron. In certain embodiments, the ground ore is a polymetallic sulphidic ore containing desired minerals wherein the desired minerals comprise two or more metals selected from copper, lead, zinc, iron, molybdenum, gold and silver. In certain embodiments, the ground ore is a polymetallic sulphidic ore containing two or more metals selected from copper, lead, zinc, iron, molybdenum, gold and silver. In certain embodiments, the ground ore is a polymetallic sulphidic ore that comprises iron and one or more metals selected from copper, lead, zinc, iron, molybdenum, gold and silver.

In embodiments, the process further comprises, after the one or more selective polysaccharide agents or flocculants has been added to the mixture, vigorously mixing the mixture to ensure uniform distribution of the selective polysaccharide agents or flocculants throughout the mixture.

In embodiments, the process further comprises, after the one or more selective flocculants has been added to the mixture, vigorously mixing the mixture to ensure uniform distribution of the selective flocculants throughout the mixture.

In embodiments, the process further comprises allowing the iron values to separate or settle from the mixture. In certain embodiments, the iron values may settle from the mixture as an underflow concentrate while the siliceous gangue material remains suspended in the supernatant liquid. In certain embodiments, the iron values may settle from the mixture as an underflow concentrate while a desired mineral material remains suspended in the supernatant liquid. Generally, effective settling is accomplished within about 30 minutes or in the range of about 5 to about 30 minutes, after the one or more selective flocculants have been added and mixed uniformly into the ore dispersion, however, the particular time of settling is not deemed critical and may vary widely depending upon the specific ore processed, the polymer composition employed, the polymer dosage applied and the like.

In embodiments, the process further comprises recovering the desired materials or minerals Such desired minerals or materials may be in the form of a concentrate. The recovery step generally occurs after sufficient settling of the mixture. This operation may be performed according to any conventional procedure while employing any conventional equipment associated with such procedures. In some embodiments, a desliming technique, such as decantation of the supernatant, followed by an additional flotation step to enhance separation and/or recovery of the desired minerals. In some embodiments, decantation of the supernatant and an additional flotation step to enhance separation and/or recovery of the desired minerals. In some embodiments, the procedure is decantation of the supernatant liquid, or any other known desliming technique, followed by a flotation step in which the remaining siliceous gangue is removed by froth flotation, leaving behind the iron values. In some embodiments, the procedure is decantation of the supernatant liquid, or any other known desliming technique, followed by a flotation step in which the remaining desired materials or minerals are removed by froth flotation, leaving behind the iron values.

In embodiments, the selective beneficiation, flotation or flocculation process results in the isolation or separation of the desired mineral from the gangue and facilitates recovery of the desired mineral. Using a process according to the embodiments, very high yields of the desired material or mineral are recovered, for example at least about 70%, about 75%, about 80%, about 85%, about 90%, or about 95% recovery of the desired material or mineral. In embodiments, the selective beneficiation, flotation or flocculation process results in the isolation or separation of the iron from the ore. Using the process, iron may be separated and recovered from the ore, for example at least about 70%, about 75%, about 80%, about 85%, about 90%, or about 95% recovery of the iron or iron-containing minerals.

In certain embodiments, the selective flocculation process results in the selective flocculation of the desired mineral when compared to the flocculation of the gangue so as to facilitate separation and recovery of the desired mineral. In certain embodiments, the selective flocculation process results in the selective flocculation of iron when compared to the flocculation of the desired mineral so as to facilitate separation and recovery of the desired mineral.

By “effective amount” of the selective polysaccharide agent or flocculant is meant an amount of the selective polysaccharide agent or flocculant that is effective in producing the desired degree of isolation or separation of the desired mineral or metal value from gangue or other minerals, which results in the desired degree of recovery of desired mineral or metal values. The particular amount that is effective will vary depending upon variables such as the particular ore processed, the specific composition of the one or more selective polysaccharide agents or flocculants, the degree of dispersion, the particle size, and the like. In some embodiments, the effective amount will range from about 0.1 to about 2.0 pounds, or about 0.1 to about 0.5 pounds, of selective polysaccharide agent or flocculant per ton of ore processed. According to alternative embodiments, the effective amount of selective polysaccharide agent or flocculant to be used in the beneficiation, flotation or flocculation process is about 1,000 to about 0.01 ppm, or about 500 to about 0.1 ppm of selective polysaccharide agent or flocculant in the beneficiation, flotation or flocculation process. In embodiments, the effective amount of selective polysaccharide agent or flocculant in the processes is about 250 to about 1 ppm, about 150 to about 5 ppm of flocculant, about 150 to about 100 ppm of selective polysaccharide agent or flocculant, about 100 to about 10 ppm or about 80 to about 15 ppm.

By “effective amount” of the selective flocculant is meant an amount of the selective flocculant that is effective in producing the desired degree of selective flocculation which, in turn, results in the desired degree of recovery of metal values, e.g., iron ore. The particular amount that is effective will vary depending upon variables such as the particular ore processed, the specific composition of the one or more selective flocculants, the degree of dispersion, the particle size, and the like. In some embodiments, the effective amount will range from about 0.1 to about 2.0 pounds, or about 0.1 to about 0.5 pounds, of selective flocculant per ton of ore processed. According to alternative embodiments, the effective amount of selective flocculant to be used in the flocculation process is about 1,000 to about 0.01 ppm, or about 500 to about 0.1 ppm of flocculant in the flocculation process. In embodiments, the effective amount of flocculant in the processes is about 250 to about 1 ppm, about 150 to about 5 ppm of flocculant, about 150 to about 100 ppm of flocculant, about 100 to about 10 ppm or about 80 to about 15 ppm.

In embodiments, a process for improving the grade of a desired mineral or matter comprises treating a mixture containing the desired mineral and gangue with one or more selective polysaccharide agents or flocculants described herein to produce a desirable mineral, and separating the desirable mineral concentrate from the gangue.

In embodiments, a process for improving the grade of a desired mineral or matter comprises selectively flocculating a mixture containing the desired mineral and gangue with one or more selective flocculants described herein to produce a desirable mineral, and separating the desirable mineral concentrate from the gangue.

In embodiments, the desirable mineral concentrate recovered from the processes described herein has an improved grade relative to the grade of the ore before the selective flocculation. In certain embodiments, the desired mineral is an iron-containing mineral, such as iron oxides or iron powder. In certain embodiments, the desired mineral contains niobium.

In embodiments, the one or more selective polysaccharide agents or flocculants may be used prior to a desliming step, such as hydrocyclone desliming. In embodiments, the selective polysaccharide agents or flocculants may be added to tailings streams of any of the processes described herein to enrich, or facilitate recovery of, a desired mineral or material from the tailings stream. Generally, “tailings” refers to the materials left over after the process of separating the valuable fraction from the uneconomic fraction.

In embodiments, a process for enriching, or facilitating recovery of, a desired mineral from a tailings stream comprising the desired mineral and gangue and/or other minerals, wherein the process comprises treating the tailings stream with one or more selective polysaccharide agents or flocculants described herein.

In embodiments, a process for enriching, or facilitating recovery of, a desired mineral from a tailings stream comprising the desired mineral and gangue and/or other minerals, wherein the process comprises carrying out a flocculation process in the presence of one or more selective flocculants described herein.

In embodiments, the tailings stream is a tailings stream of a desliming process. In embodiments, the tailings stream is a tailings stream of a flotation process. In embodiments, the tailings stream comprises an iron-containing mineral. In embodiments, the tailings stream comprises oxides of silica, silicates or siliceous materials. In certain embodiments, the tailings stream comprises about 10 to about 50% iron-containing compounds. In certain embodiments, the tailings stream comprises niobium. In certain embodiments, the tailings stream comprises polymetallic sulphidic ore.

In embodiments, the process for enriching a desired mineral from a tailings stream comprises the steps of:
(i) adding one or more selective polysaccharide agents or flocculants to the tailings stream to form a mixture;
(ii) agitating the mixture to distribute the one or more selective polysaccharide agents or flocculants;
(iii) allowing flocs or layers to form; and
(iv) isolating the flocs or separating the layers.

In embodiments, the process for enriching a desired mineral from a tailings stream comprises the steps of:
(i) adding one or more selective flocculants to the tailing stream to form a mixture;
(ii) agitating the mixture to distribute the one or more selective flocculants;
(iii) allowing flocs to form; and
(iv) isolating the flocs.

In embodiments, the one or more selective polysaccharide agents or flocculants may be used to separate desired minerals or materials, such as niobium, from iron or iron-containing minerals in a tailings stream.

In embodiments, the one or more selective polysaccharide agents or flocculants may be used to enrich iron-containing minerals in a tailings stream containing iron-containing ore, including magnetite, hematite, taconite or itabirite.

Other flocculants may be used in combination with the selective polysaccharide agents or flocculants and are not particularly limited and include: starch such as starch derived from tapioca, corn, potato, wheat, rice and the like; starch activated by treatment with alkali; cellulose esters, such as carboxymethylcellulose and sulphomethylcellulose; cellulose ethers, such as methyl cellulose, hydroxyethylcellulose and ethyl hydroxyethylcellulose; hydrophilic gums, such as gum arabic, gum karaya, gum tragacanth and gum ghatti, alginates; starch derivatives, such as carboxymethyl starch and phosphate starch; and combinations thereof. In certain embodiments, the selective polysaccharide agents or flocculants may be used in combination with selective flocculants comprising a polymer comprising a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers.

According to various embodiments, the amount of selective beneficiation or flotation may be quantified. For example, the amount of selective beneficiation or flotation may be quantified according to the percent improvement of the mineral grade, i.e., the change in percent by weight of the valuable mineral in the concentrated material compared to the material before the froth flotation process. In embodiments, use of the selective polysaccharide agent or flocculant causes valuable metal grade to increase by at least about 1%, about 1.5%, about 2%, about 2.5%, about 3%, about 4%, about 5%, about 6%, about 7%, about 8%, about 8%, or about 10%.

According to various embodiments, the amount of selective flocculation may be quantified. For example, the amount of selective flocculation may be quantified according to the percent improvement of the mineral grade, i.e., the change in percent by weight of the valuable mineral in the concentrated material compared to the material before the froth flotation process. In embodiments, use of the selective flocculant causes valuable metal grade to increase by at least about 1%, about 1.5%, about 2%, about 2.5%, about 3%, about 4%, about 5%, about 6%, about 7%, about 8%, about 8%, or about 10%. Even relatively modest amounts of improvement to the recovered metal grade may represent significant increases in production and profitability of the method over time.

In embodiments, a process for enriching an iron-containing mineral from an ore having the iron-containing material and silicate-containing gangue, includes carrying out a selective flocculation step prior to a flotation process in the presence of one or more dispersing agents. In embodiments, a process for enriching an iron-containing mineral from an ore having the iron-containing material and a desired mineral or material, includes carrying out a selective flocculation step prior to a flotation process in the presence of one or more dispersing agents.

In embodiments, the one or more dispersing agents are added at any stage of the process prior to the settling step. In certain embodiments, the one or more dispersing agents are added before or with the addition of the disclosed selective flocculating agents.

According to an embodiment, the process produces: a top fraction which is a gangue-enriched dispersion, for example, a silicate-enriched dispersion; and a bottom fraction which is rich in the desired mineral or material (underflow), for example, iron.

According to an embodiment, the process produces: a top fraction which is a dispersion comprising the desired minerals or materials; and a bottom fraction which is rich in the iron or iron-containing material.

According to an embodiment, the process produces: a top fraction which is a desired mineral-enriched dispersion and a bottom fraction which is rich in the gangue and/or other minerals. According to an embodiment, the process produces: a top fraction which is a dispersion enriched in iron or iron-containing material, and a bottom fraction which is rich in desired minerals or materials.

According to an embodiment, the selective flocculation process produces: a top fraction which is a gangue-enriched dispersion, for example, a silicate-enriched dispersion; and a bottom fraction which is rich in the desired mineral (underflow), for example, iron.

According to an embodiment, the selective flocculation process produces: a top fraction which is a desired-mineral-enriched dispersion, for example, a niobium-enriched dispersion; and a bottom fraction which is rich in the iron-containing gangue.

According to the embodiments, one or more steps may be performed prior to the treatment of the ore with the selective polysaccharide agents or flocculants, or prior to the selective flocculation step, to prepare the ore for flocculation and/or flotation. For example, in one step of the process, the ore may be ground, together with water, to the desired particle size, to produce a slurry. The grain size of the ore and its degree of comingling with the silica groundmass determine the grind size to which the rock must be reduced to enable efficient separation, e.g., via subsequent desliming and froth flotation, to provide a high purity metal concentrate. An exemplified average particle size is less than about 1 mm, e.g., in the range of about 1 to about 300 μm, about 5 and 200 μm, about 5 and 150 μm, or about 5 to about 50 μm.

Optionally, conditioning agents such as sodium hydroxide and/or sodium silicate may be added to the grinding mill prior to grinding the crude ore. In an embodiment, sufficient water is added to the grinding mill to provide a slurry suitable for subsequent processing, as would be well understood in the art, for example, containing about 50% to about 70% solids, although this amount is understood to be not particularly limited.

In embodiments, a base or alkali pH adjuster may be added to adjust the pH of the slurry. For example, a pH adjuster may be added to the slurry to produce a pH in the range of about 6 to about 11, about 8 to about 11, about 9 to about 11, about 10 to about 11, about 8.5 to about 10.5, or about 9.5 to about 10.5. In certain embodiments, the pH may be adjusted to about 8.5, about 9.5 or about 10.5. In embodiments, the pH of the slurry in the flocculation cell is maintained at between about 6 and about 11, or about 8 and about 11. In embodiments, the pH may be adjusted to produce optimum iron recoveries.

According to the embodiments, the selective flocculation process may include a step of adding one or more dispersing agents. For example, the dispersing agents may be added to the mixture before, after, or during the addition of the one or more selective flocculants and/or any other process agents.

In embodiments, the selective flocculation process may include a step involving conditioning or agitation of the mixture. For example, once all of the occur before or after other processing agents have been added to the mixture, the mixture may be further conditioned or agitated for a period of time before the settling step is carried out.

In embodiments, the selective flocculation process may be performed in a plurality of flocculation processing steps. For example, the selective flocculation process may be performed in flocculation units containing a plurality of communicating cells in series, with the first cell(s) being generally used for the rougher settling, and subsequent cell(s) being used for the more refined settling.

In embodiments, before beneficiation, flotation or flocculation treatment, the ore-water slurry comprises about 20 to about 60%, or about 30 to about 50%, by weight solids. In embodiments, the duration of the selective flocculation process depends upon the desired result. In embodiments, the time of beneficiation, flotation or flocculation treatment may be from about 1 to about 10 minutes for each circuit. The time of the beneficiation, flotation or flocculation process may depend, at least in part, upon the gangue content, the grain size of the ore being treated and the number of flocculation cells involved.

In embodiments, the selective polysaccharide agents or flocculants, compositions and processes may be used to provide higher selectivity and desired mineral recoveries, as compared to other flocculants, when used in flocculation processes. In embodiments, the treated or flocculated mineral concentrate, e.g. hematite concentrate, that is obtained by the processes, with or without subsequent flotation processing, is a refined mineral concentrate that meets the specifications for the steel industry. In embodiments, the selective polysaccharide agents or flocculants, compositions and processes may be used to maximize the desired mineral or metal values recovery to increase production of metallic charge per unit ore fed, which in turn provides increases in production and profitability. In embodiments, the selective polysaccharide agents or flocculants, compositions and processes may be used to maximize the iron recovery to increase production of metallic charge per unit ore fed, which in turn provides increases in production and profitability.

In embodiments, the selective polysaccharide agents or flocculants, compositions and processes described herein may be used to improve the grade of the desired mineral or material at least about 0.5%, about 1%, about 2%, about 3%, or about 5%.

In embodiments, the selective polysaccharide agents or flocculants, compositions and processes described herein may be used to improve the grade of iron from iron ore such that the grade of the recovered iron is at least about 55%, about 56%, about 57%, about 58%, about 59%, about 60%, about 61%, about 61%, or about 63%. In embodiments, the selective polysaccharide agents or flocculants, compositions and processes described herein may be used to improve the grade of iron from iron ore such that the grade of the recovered iron is in the range of about 55% to about 64%, about 56% to about 64%, about 57% to about 64%, or about 58% to about 64%.

In embodiments, the selective polysaccharide agents or flocculants, compositions and processes described herein may be used to improve the grade of iron from iron ore by at least about 0.5%, about 1%, about 1.5%, about 2%, about 2.5%, about 3%, about 3.5%, about 4%, about 4.5%, about 5%, about 5.5%, or about 6%. For example, the selective polysaccharide agents or flocculants, compositions and processes described herein may be used to improve the grade of iron from iron ore with an initial iron grade of about 58% to a grade of at least about 58.5%, about 59%, about 59.5%, about 60%, about 60.5%, about 61%, about 61.5%, about 62%, about 62.5%, or about 63%.

In embodiments, the selective polysaccharide agents or flocculants, compositions and processes described herein may be used to improve the grade of iron from iron ore by about 0.5% to about 7%, about 1% to about 7%, about 1.5% to about 6%, or about 4.5% to about 6%.

In embodiments, the selective polysaccharide agents or flocculants, compositions and processes described herein may be used to improve the grade of iron oxide from iron ore such that the grade of the recovered iron oxide is at least about 80%, about 81%, about 82%, about 83%, about 84%, about 85%, about 86%, about 87%, about 88%, about 89%, about 90%, about 91%, or about 92%. In embodiments, the selective polysaccharide agents or flocculants, compositions and processes described herein may be used to improve the grade of iron oxide from iron ore such that the grade of the recovered iron oxide is in the range of about 81% to about 92%, about 82% to about 90%, or about 82% to about 88%.

In embodiments, the selective polysaccharide agents or flocculants, compositions and processes described herein may be used to improve the recovery of iron from iron ore to at least about 50%, about 60%, about 62%, about 65%, about 70%, about 75%, about 80%, about 85%, or about 90%. In embodiments, the selective polysaccharide agents or flocculants, compositions and processes described herein may be used to improve the recovery of iron from iron ore such that the recovery of iron is in the range of about 50% to about 100%, about 60% to about 98%, about 70% to about 98%, or about 80% to about 98%.

In embodiments, the polysaccharide agents or flocculants, compositions and processes may be used to reduce the amount of silica in the iron ore to less than about 22%, about 21%, about 20%, about 19%, about 18%, about 17%, about 16%, about 15%, about 14%, about 13%, about 12%, about 11%, about 10%, about 9%, about 8%, about 7%, about 6%, about 5%, about 4%, about 3%, or about 2%.

The following examples are presented for illustrative purposes only, and are not intended to be limiting.

### EXAMPLES

### Example 1: Flocculation Test with Iron Ore and Exemplary Selective Flocculant

In this example, flocculation tests were conducted on a laboratory scale and the objective of these tests was to separate the mineral of interest (iron oxide) from gangue (SiO₂). The exemplary selective flocculant, selective flocculant X, used in these experiments was a blend of polysaccharides present in plant cell walls comprising mainly xylan. Selective flocculant X may be prepared extracting corn fiber in deionized water containing NaOH and H₂O₂ at about 70-80° C. for 2-16 h. Solids were removed by centrifugation and the depressant X solution may be stored in a refrigerator until use.

Starch was used as the flocculant in the comparative experiments.

Flocculation tests were done on a laboratory scale in a 2 L cylinder. An iron ore desliming overflow sample (from a Brazilian iron mine) with 7.5% solids was used in these experiments after pH adjustment to pH 10.5 with sodium hydroxide. 2160 grams of the pH-adjusted iron ore slurry material (160 g dry iron ore) were weighed and combined with sufficient water to bring the sample volume up to 2 L. Starch, or the exemplary selective flocculant, was then added in the desired amount, and the contents of the cylinder were fully mixed for 5 minutes. The mixture was then allowed to settle for 1 minute and the top layer (overflow) was separated from the bottom (underflow) by a siphon device. The overflow (OF) and underflow (UF) layers were dried and measured by X-ray fluorescence. The results are provided in Table 1.

TABLE 1
Selective flocculation from desliming overflow using
starch and selective flocculant X as flocculants

| | | Starch | | X | | X | |
|---|---|---|---|---|---|---|---|
| | Feed | (20 ppm) | | (30 ppm) | | (50 ppm) | |
| | OF- | OF- | UF- | OF- | UF- | OF- | UF- |
| | Deslime | RJ | CO | RJ | CO | RJ | CO |
| Fe | 53.3 | 44.9 | 53.9 | 43.4 | 56.3 | 40.1 | 55.8 |
| SiO₂ | 14.5 | 10.5 | 13.8 | 12.7 | 15.4 | 13.0 | 15.0 |
| P | 0.14 | 0.35 | 0.12 | 0.31 | 0.06 | 0.35 | 0.06 |
| Al₂O₃ | 4.8 | 10.8 | 5.1 | 10.7 | 2.4 | 12.2 | 2.5 |
| Mn | 0.7 | 2.0 | 0.6 | 1.9 | 0.2 | 2.2 | 0.2 |
| TiO₂ | 0.2 | 0.4 | 0.2 | 0.4 | 0.1 | 0.4 | 0.1 |
| CaO | 0.4 | 0.3 | 0.1 | 0.2 | 0.1 | 0.3 | 0.1 |
| MgO | 0.1 | 0.2 | 0.1 | 0.2 | 0.1 | 0.3 | 0.1 |
| Loss of Ignition | 3.7 | 9.6 | 3.9 | 10.1 | 1.9 | 11.9 | 1.9 |
| Others (%) | 10.1 | | 10.1 | | 4.9 | | 1.9 |
| Metallic Recovery | | | 97.3 | | 81.1 | | 88.1 |
| (%) | | | | | | | |
| Mass Recovery (%) | | | 96.8 | | 76.8 | | 84.2 |

RJ = Reject;
CO = Concentrate

It was observed that the exemplary selective flocculant, when used in the flocculation tests, improved the iron grade more than starch. Exemplary selective flocculant is capable of preventing the flocculation of other contaminants, including phosphorus, aluminum, manganese, titanium, calcium, and magnesium.

### Example 2: Flocculation Test with Ultrafine Iron and Exemplary Selective Flocculant

In this example, flocculation tests were conducted on a laboratory scale and the objective of these tests was to separate the mineral of interest (iron oxide) from gangue (SiO₂). The exemplary selective flocculant was selective flocculant X, described above.

Starch was used as the flocculant in the comparative experiments.

Flocculation tests were done on a laboratory scale in a 2 L cylinder. An iron ore desliming feed sample (from a Brazilian iron mine) with 25% solids was used in these experiments after pH adjustment to a desired pH (pH 8.5, 9.5 or 10.5) with sodium hydroxide. 2460 grams of the pH-adjusted iron ore slurry material (615 g dry iron ore) were weighed and combined with sufficient water to bring the sample volume up to2 L. The exemplary selective flocculant, was then added in an amount in the range of about 100 to about 150 g/ton, and the contents of the cylinder were fully mixed for 5 minutes. The mixture was then allowed to settle for 15 minutes and the top layer (overflow) was separated from the bottom (underflow) by a siphon device. The overflow (OF) and underflow (UF) layers were dried and measured by X-ray fluorescence. The results are provided in Table 2.

TABLE 2
Selective flocculation from desliming feed using
selective flocculant X at pH 8.5, 9.5 or 10.5

| | Feed | pH 8.5 | | pH 9.5 | | pH 10.5 | |
|---|---|---|---|---|---|---|---|
| | ROM | UF | OF | UF | OF | UF | OF |
| Fe (%) | 47.9 | 47.7 | 31.2 | 45.2 | 33.8 | 47.5 | 33.7 |
| P (%) | 0.058 | 0.031 | 0.398 | 0.022 | 0.296 | 0.023 | 0.308 |
| PPC (%) | 1.2 | 0.7 | 14.3 | 0.6 | 10.7 | 0.6 | 10.7 |
| Al₂O₃ (%) | 2.6 | 1.5 | 17.6 | 1.0 | 14.9 | 1.1 | 14.9 |
| SiO₂ (%) | 27.1 | 28.7 | 17.7 | 33.3 | 21.5 | 30.0 | 21.8 |
| Mn (%) | 0.32 | 0.14 | 2.31 | 0.09 | 1.92 | 0.09 | 2.02 |

| | | | |
|---|---|---|---|
| Mass Recovery (%) | 98.4 | 94.5 | 94.5 |
| Metallic Recovery (%) | 97.9 | 89.3 | 93.8 |

Several dosages of the selective flocculant were evaluated for the flocculation tests. For example, at pH 9.5, dosages of 110, 125 and 150 g/ton were tested. These results are shown in Table 3.

TABLE 3
Selective flocculation from desliming overflow using
different dosages of selective flocculant X at pH 9.5

| | | X | | X | | X | |
|---|---|---|---|---|---|---|---|
| | Deslime | (150 g/ton) | | (110 g/ton) | | (125 g/ton) | |
| | Feed | OF | UF | OF | UF | OF | UF |
| Fe | 47.9 | 36.8 | 47.8 | 31.4 | 49.3 | 31.4 | 51.7 |
| SiO₂ | 27.1 | 23.4 | 29.3 | 25.4 | 28.3 | 23.4 | 24.4 |
| Al₂O₃ | 2.64 | 13.0 | 1.09 | 14.1 | 0.58 | 14.5 | 0.75 |
| P | 0.06 | 0.2 | 0.03 | 0.3 | 0.02 | 0.3 | 0.03 |
| TiO₂ | 0.06 | 0.2 | 0.10 | 0.2 | 0.10 | 0.2 | 0.10 |
| Mn | 0.32 | 1.9 | 0.12 | 2.3 | 0.06 | 2.2 | 0.09 |
| CaO | 0.02 | 0.1 | 0.03 | 0.1 | 0.04 | 0.1 | 0.04 |
| K₂O | 0.05 | 0.2 | 0.01 | 0.2 | 0.01 | 0.2 | 0.01 |
| Loss of Ignition | 1.23 | 5.2 | 0.87 | 10.3 | 0.39 | 11.2 | 0.57 |
| (1000° C.) | | | | | | | |
| Others (%) | 4.4 | 20.9 | 2.3 | 27.5 | 1.2 | 28.7 | 1.6 |

| | | | |
|---|---|---|---|
| Iron Recovery (%) | 95.7 | 95.9 | 97.1 |
| Mass Recovery (%) | 95.9 | 95.6 | 96.9 |

### Example 3: Flotation Test with Exemplary Selective Polysaccharide Agent

In this example, a dosage (700 or 900 g/ton) of the comparative or exemplary polysaccharide agent and a dosage (60, 90 or 120 g/ton) of a collector were added to a desliming feed including ultrafine iron ore just after desliming by hydrocyclones. The feed then proceeded to a conditioning stage for 5 minutes, and then on to the flotation stage of the process. After flotation, the concentrate was separated from the tailings. The initial feed in this Example included 51.44% Fe and 21.23% SiO₂.

The exemplary selective polysaccharide agent was selective flocculant X, described above. Starch was used in place of the exemplary selective polysaccharide agent in the comparative experiments.

The chemical analysis of the concentrate is provided in in Table 4.

TABLE 4
Treatment of desliming feed using starch or an
exemplary polysaccharide agent

| | | | | | | | | | | | Mass | Metallic | Selective |
|---|---|---|---|---|---|---|---|---|---|---|---|---|---|
| | CO (%) | | | | | Tails (%) | | | | | Rec. | Rec. | Index |
| ID | Fe | SiO₂ | Al₂O₃ | P | Mn | Fe | SiO₂ | Al₂O₃ | P | Mn | (%) | (%) | (%) |
| T1 | 66.6 | 1.12 | 0.82 | 0.05 | 0.15 | 34.9 | 43.2 | 2.06 | 0.04 | 0.13 | 52.2 | 67.6 | 8.6 |
| T2 | 67.1 | 0.60 | 0.81 | 0.05 | 0.15 | 38.7 | 38.6 | 1.93 | 0.04 | 0.13 | 45.0 | 58.7 | 10.6 |
| T3 | 67.0 | 0.51 | 0.82 | 0.05 | 0.15 | 38.9 | 38.5 | 1.89 | 0.04 | 0.12 | 44.7 | 58.2 | 11.4 |
| T4 | 66.7 | 1.25 | 1.01 | 0.05 | 0.18 | 24.6 | 57.3 | 2.26 | 0.02 | 0.07 | 63.8 | 82.7 | 11.1 |
| T5 | 66.1 | 0.99 | 0.99 | 0.05 | 0.18 | 19.4 | 68.5 | 2.16 | 0.03 | 0.06 | 68.8 | 88.2 | 15.4 |
| T6 | 66.7 | 0.80 | 0.99 | 0.05 | 0.18 | 21.5 | 61.5 | 2.39 | 0.02 | 0.06 | 66.3 | 85.9 | 15.4 |

Sample ID descriptions for Table 4:
T1=900 g/ton starch and 60 g/ton collector
T2=900 g/ton starch and 90 g/ton collector
T3=900 g/ton starch and 120 g/ton collector
T4=700 g/ton exemplary polysaccharide agent and 60 g/ton collector
T5=900 g/ton exemplary polysaccharide agent and 60 g/ton collector
T6=700 g/ton exemplary polysaccharide agent and 60 g/ton collector; conditioned for 15 minutes.

In the preceding procedures, various steps have been described. It will, however, be evident that various modifications and changes may be made thereto, and additional procedures may be implemented, without departing from the broader scope of the exemplary procedures as set forth in the claims that follow.

1. A process for enriching a desired mineral or material from an ore having iron-containing material and/or silicate-containing gangue, includes treating the ore in an aqueous medium with one or more selective polysaccharide agents or flocculants comprising one or more types of pentosan units.

2. The process of claim 1, wherein the desired mineral is an iron-containing mineral.

3. The process of claim 1, wherein the gangue comprises oxides of silica, silicates or siliceous materials.

4. The process of claim 1, wherein the process comprises the steps of:
(i) mixing a ground ore with a solvent to form a mixture;
(ii) adding the one or more selective polysaccharide agents or flocculants to the mixture;
(iii) agitating the mixture to distribute the selective polysaccharide agents or flocculants;
(iv) allowing flocs to form; and
(v) isolating the flocs.

5. The process of claim 1, wherein the one or more selective flocculants are added to tailings streams.

6. A process for enriching, or facilitating recovery of, a desired mineral from a tailings stream comprising the desired mineral and gangue and/or other minerals, wherein the process comprises treating the tailings stream with one or more selective polysaccharide agents or flocculants comprising one or more types of polysaccharides comprising one or more types of pentosan units.

7. The process of claim 6, wherein the tailings stream is a tailings stream of a desliming process.

8. The process of claim 6, wherein the tailings stream is a tailings stream of a flotation process.

9. The process of claim 6, wherein the tailings stream comprises an iron-containing mineral.

10. The process of claim 6, wherein the gangue comprises oxides of silica, silicates or siliceous materials.

11. The process of claim 1 wherein the one or more selective polysaccharide agents or flocculants is added in the form of a composition comprising the selective polysaccharide agent or flocculant and a solvent.

12. The process of claim 11, wherein the solvent is water.

13. The process of claim 1, wherein the process comprises a beneficiation process.

14. The process of claim 1, wherein the process comprises a flotation process.

15. The process of claim 1, wherein the process comprises a flocculation process.

16. The process of any one of the preceding claims, wherein the one or more types of polysaccharides are derived from one or more types of lignocellulosic biomass.

17. The process of any one of the preceding claims, wherein the lignocellulosic biomass is selected from the group consisting of: herbaceous crops, wood and agricultural residues.

18. The process of any one of the preceding claims, wherein the agricultural residue is selected from the group consisting of sugarcane bagasse, wheat straw, corn stover, corn fiber and mixtures thereof.

19. The process of claim 6 wherein the one or more selective polysaccharide agents or flocculants is added in the form of a composition comprising the selective polysaccharide agent or flocculant and a solvent.
